(19) United States
(12) Patent Application Publication
(10) Pub. No.: US 2023/0284672 A1
(43) Pub. Date: Sep. 14, 2023

(54) Defoliator

(71) Applicant: Dustin David Ambrose, Mesa, AZ (US)

(72) Inventor: Dustin David Ambrose, Mesa, AZ (US)

(73) Assignee: Dustin David Ambrose

(21) Appl. No.: 17/803,160

(22) Filed: Mar. 11, 2022

(51) Int. Cl. A24B 7/00; A47J 42/40; A47J 42/34

(52) U.S. Cl. CPC A24B 7/00; A47J 42/40; A47J 42/34

(57) ABSTRACT

A grinder/manual defoliation device specifically adapted to separate soft foliage material from all stems and hard material such as seeds and hard plant nodules, including micro stems. The Defoliator has a unique top texture consisting of soft angles and flat surfaces, and a Screen area consisting of angular openings in the screen and a textured surface that when used in conjunction with the top texture together forms a complete defoliation system. Orienting the stems and hard material in a way so they may not pass through the screen, Even though the Defoliator is manually operated the device is operated with ease. It does not employ cutting blades, mulching designs or laser sharpened edges making the device safe for the consumer to use. This Defoliator is specifically designed for dried, cured and manicured Cannabis and herbal material such as saffron, rosemary, Basil or Bay leafs

### CROSS REFERENCE TO RELATED APPLICATIONS

The present application is not related to a CO pending provisional patent

Customer number 177675 is given as further reference

### STATEMENT REGARDING FEDERALLY SPONSORED RESEARCH OR DEVELOPMENT

Not applicable

### THE NAMES OF THE PARTIES TO A JOINT RESEARCH OR DEVELOPMENT

Not applicable

### INCORPORATION BY REFERENCE OF MATERIAL SUBMITTED ON A COMPACT DISC AS A TEXT FILE VIA THE OFFICE ELECTRONIC FILING SYSTEM (EFS-WEB)

Not applicable

### STATEMENT REGARDING PRIOR DISCLOSURE BY THE INVENTOR OR A JOINT INVENTOR

No prior disclosure was ever given on this product

### BACKGROUND OF THE INVENTION

1: Field of the Invention

The present invention relates generally to the field of grinders for herbs, including grinders for tobacco, herbal material and Cannabis materials, and more particular to hand held and manually operated apparatus, and to methods and systems for herb grinders, which are adapted to deliver sifted and clean ground material into an empty collection chamber.

2. Description of the Related Art Including Information Disclosed/Background Art

There is a great need in the growing Herbal and Cannabis market for a healthier way to consume plant material. As millions of Americans flock to health stores to buy vitamins so do millions of Americans flock to herbal supplements and all natural herbal remedies including Cannabis, Rosemary, Turmeric, Basil or Saffron. This is where the Defoliator comes in by taking all natural plant based material and defoliating it, simply separating all plant material from stock, seed and stem. The current market is limited to a few basic designs mainly cutting grinding and chopping blades or surfaces. None of which are designed to separate out unwanted material like stems, seeds and hard plant material. Unlike all others on the market this simple design defoliates usable Cannabis and herbal material from unwanted stems and seeds including micro stems that have never in the past been able to be separated out, even by hand. Before the Defoliator the grinding process was dangerous and unforgiving one could say almost barbaric in their means. The current models on the market employ sharp pointy and laser cut edges to shred, tear, chop and mulch all material, including stems and seeds into a usable yet somewhat unhealthy consumable product, that will produce unwanted side effects like extra coughing, bitter taste and headaches. These products are also dangerous to the user as often pieces of Cannabis or herbal material will Lodge itself inside the grinder, forcing the user to pick it out with their fingers, resulting in cuts, scratches or a nasty poke in some cases, resulting in the need for medical attention. See cited patents below.
Cannabis personal processor apparatus
Benson: Jeffrey
U. S. P u b. No. 2018/10028618

### Relates to

1. The device is electric and uses chopping blades rather than a cutting blade Relates to
2. it is different from a grinder in that it is not designed to cut the bud with a blade but to chop the bud and removed the leaf from the stem this provides a much better flavor for the marijuana smoke it chops the bud so that the leaf portion falls through the screen below the chopping blades and keeps the stem on the top of the screen and does not fall through the screen.
Herb grinder system
Staiano: Mark
U. S. P u b. No. 2020/10617259

### Relates to

1. The upper and lower grinding plates are provided with blades having a modified diamond shape which provides extremely sharp leading edges.
Portable electric and hand operated herb grinder
Mroue: Heba
2019/10478825

### Relates to

1. A dried herb or Leaf is placed inside the first chamber the top cap is then rotated relative to the rest of the grinder allowing the grinding knives to cut the herb into small pieces.

Unlike others on the market the Defoliator equips itself with soft angles, flat surfaces and a textured screen to defoliate the material and leave all stems and seeds including micro stems and hard material behind. Leaving the consumer with a healthier product lacking in all unwanted chemicals and material, others on the market rely on large holes beneath the cutting chopping or mulching area to move all material including stems and seeds to the collection area. The Defoliator employees truncated pyramids and one textured screen small enough to keep all stems including micro stems and hard plant material on top of the screen, allowing clean Cannabis and Herbal foliage material to pass to the collection chamber ready for a cleaner and healthier consumption for the consumer.

### BRIEF SUMMARY OF THE INVENTION

The present invention relates generally to the field of grinders for herbs, including grinders for tobacco, herbal material and Cannabis materials, and more particular to hand held and manually operated apparatus, and to methods and systems for herb grinders, which are adapted to deliver sifted and clean ground material into an empty collection chamber.

It is an object of the present invention The Defoliator to separate/defoliate all Cannabis and herbal foliage material from stem material including micro stems and hard plant nodules producing a cleaner healthier consumable product, with minimal effort to the consumer and absolutely no hand-picking of any stems or seeds will be necessary.

It is another object of the Defoliator to make a product that will not only hold up to the test of time but will outlive others like it on the market.

It is another object of the Defoliator to make Cannabis and herbal foliage consumption as healthy as possible by removing all stems including micro stems and hard plant material out of consumable product, that until the Defoliator was not possible and was subsequently consumed creating extra coughing, bitter taste and headaches as well as destroying rolling papers by putting holes in them rendering them unusable.

This paragraph discloses a Cannabis and Herbal Defoliator/grinder put simply a device that strips foliage from stem and trunk and separates it leaving a healthier end product.

The first piece of The Defoliator is composed of a descending cylindrical body having a slight taper from top to bottom, At the bottom of this cylindrical body are a series of truncated pyramids composed of 90 degree angles and flat surfaces extending downward and composing the entire bottom of the cylindrical body. At the top of this cylindrical body is a flat round cap that extends slightly wider than the lower cylindrical device Top Peg ensuring a seamless fit when the cylindrical Body is inserted into the next part Separation Chamber.

Separation Chamber Is composed of a hollow cylinder having 0.50 inch thick walls and brass rods fixed to the bottom of the hollow cylinder.

The next piece is actually composed of three separate pieces glued and pressed together.

First is a 0.25 inch tall Hollow cylinder with an inside diameter of two inches matching that of the separation chamber with 0.50 inch thick walls.

The next part is able to be made with 3 different screens and 4 different types but one is preferable. They are as follows.

Double Crimp in 304 Stainless-steel 18 Mesh 0.017 wire, 304 Stainless Steel 20 Mesh 0.016 wire or 304 Stainless Steel 16 Mesh 0.018 wire.

Double Intermediate Crimp in 304 Stainless-steel 18 Mesh 0.017 wire, 304 Stainless Steel 20 Mesh 0.016 wire or 304 Stainless Steel 16 Mesh 0.018 wire.

Inter Crimp in 304 Stainless-steel 18 Mesh 0.017 wire, 304 Stainless Steel 20 Mesh 0.016 wire or 304 Stainless Steel 16 Mesh 0.018 wire.

Plain weave in 304 Stainless-steel 18 Mesh 0.017 wire, 304 Stainless Steel 20 Mesh 0.016 wire or 304 Stainless Steel 16 Mesh 0.018 wire.

All of these variations will produce a good even consistency and separation but the preferred screen and type is Double Crimp 304 Stainless Steel 16 Mesh 0.018 wire.

When combined with the truncated pyramids and the containment of the herbal material in the Separation Chamber the Defoliator will orient all stems and foliage material into a horizontal path keeping the stem and harder herbal material from orientating themselves in a vertical path and falling through the screen, and at the same time abrading all stems allowing you to maximize the raw material that clings close to the stems. Third is a 0.25 in tall Hollow cylinder with an inside diameter of 2 inches matching that of the separation chamber with 0.50 inch thick walls. These two screen attachments will have one of the above stated screens glued and pressed between them. Holes will be drilled evenly around the piece to accommodate 3 brass rods that will be used to hold all pieces together and are attached permanently to the bottom of the Separation chamber. The bottom piece of the Defoliator is a hollow cylinder 1.25 inches tall with 0.50 inch thick walls and a 0.50 inch thick bottom and a 0.75 inch deep hole. When all pieces are put together it makes a seamless semi small grinder/stem removal/Defoliator that will create a healthier consumable product by separating all stems and seeds including micro stems and hard plant nodules out of the consumable product, and allowing the consumable product to fall with ease into the bottom collection chamber where it is then ready for a healthier consumption by the consumer.

### BRIEF DESCRIPTION OF THE SEVERAL VIEWS OF THE DRAWINGS

FIG. 1 is an exploded view showing the first four elements of The Defoliator.

FIG. 2 Is an exploded view of the three remaining pieces of The Defoliator.

FIG. 3 is a perspective view of The Defoliator with all pieces put together.

FIG. 4 Is a side view of Top Peg.

FIG. 5 Is a top view of Top Peg.

FIG. 6 Is a bottom view of Top Peg.

FIG. 7 Is a close up top view of Texture on bottom of Top Peg.

FIG. 8 is a three dimensional close up of Texture on bottom of Top Peg.

FIG. 9 is a side view of Separation Chamber.

FIG. 10 is a top view of Separation Chamber.

FIG. 11 is a bottom view of Separation Chamber.

FIG. 12 is a side view of Screen Attachment-A.

FIG. 13 is a top view of Screen Attachment-A.

FIG. 14 is a bottom view of Screen Attachment-A.

FIG. 15 is top view of Screen.

FIG. 16 is a side view of Screen.

FIG. 17 is a bottom view of Screen.

FIG. 18 is a side view of Screen Attachment-A.

FIG. 19 is a top view of Screen Attachment-B.

FIG. 20 is a bottom view of Screen Attachment-B

FIG. 21 is a side view of Collection Chamber.

FIG. 22 is a top view of Collection Chamber.

FIG. 23 is a bottom view of Collection Chamber.

FIG. 24 is a side view of Brass attachment rods.

FIG. 25 is a top view of Brass Attachment rods.

FIG. 26 is a bottom view of Brass Attachment rods.

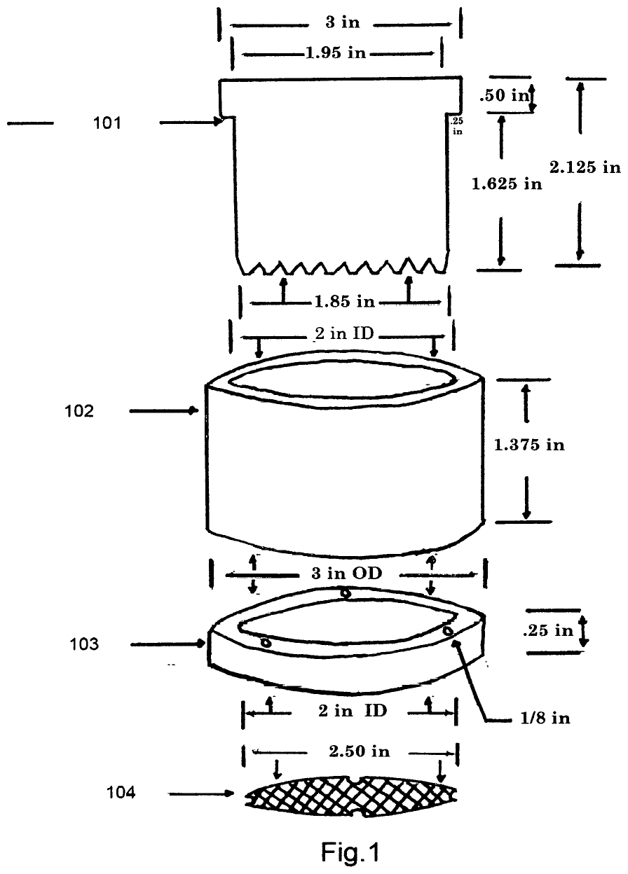

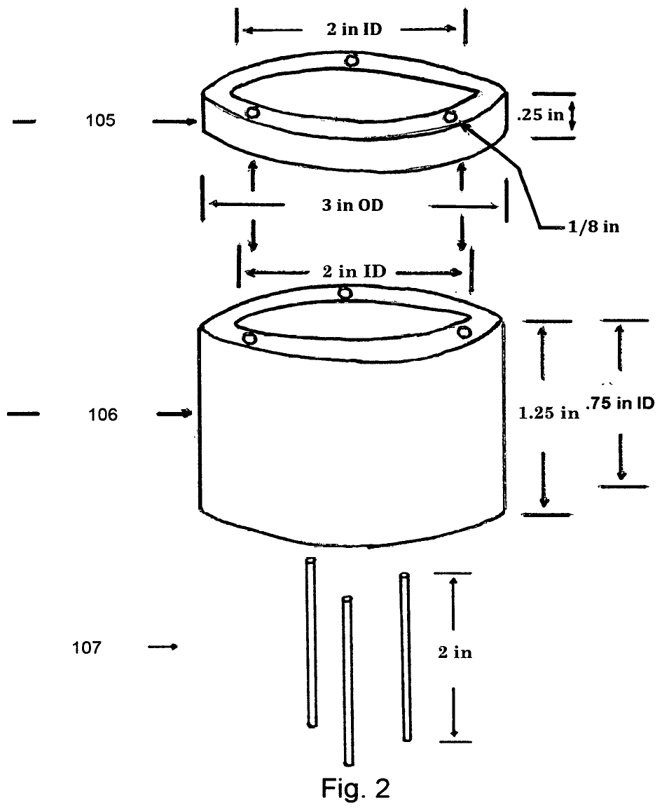

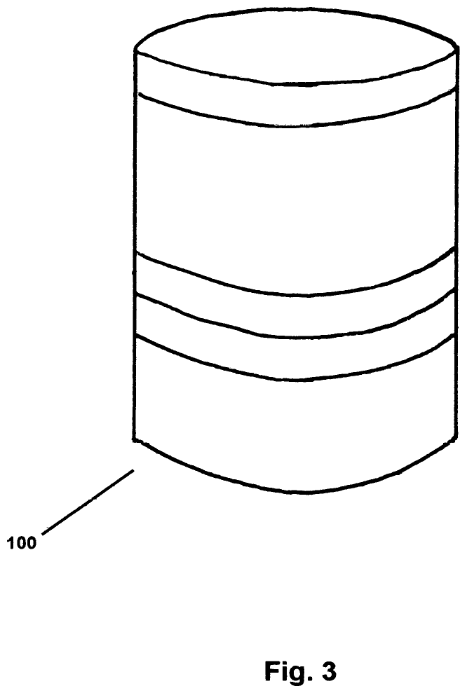

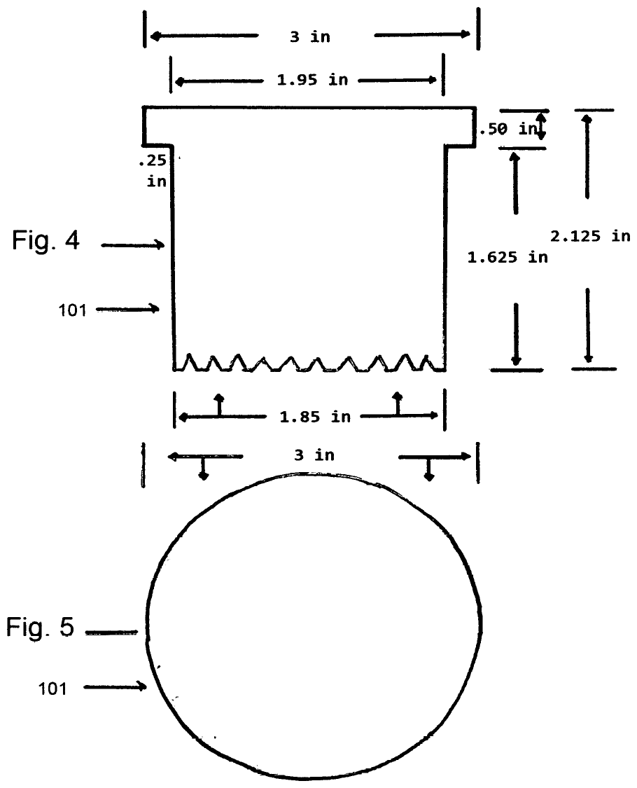

### DETAILED DESCRIPTION OF THE INVENTION

In this detailed description references to Center, Bottom, Top, and Outer Perimeter. Inner perimeter, Outside and Inside Are simply referring to The area on the part being described or are being used if a view is being referenced the reference will be Followed By the word view and the view number reference.
The structure of the detailed description will first show what the Defoliator does as a whole.
Second what makes the Defoliator stand out from all others on the market?
Third How to manufacture the Defoliator.
And finally how to use the Defoliator and What the Defoliator does:

The Defoliator is not merely a grinder it is a defoliator, stripping foliage from stem and trunk, which in layman's terms means it separates all Leaf material from stem and trunk leaving the stem including micro stems and hard plant nodules above the screen and the healthier consumable material in the Collection chamber below. This is all done with very little effort from the consumer by using truncated pyramids with soft edges and flat surfaces when used in conjunction with one of the below stated screens.

Double Crimp in 304 Stainless-steel 18 Mesh 0.017 wire, 304 Stainless Steel 20 Mesh 0.016 wire or 304 Stainless Steel 16 Mesh 0.018 wire.

Double Intermediate Crimp in 304 Stainless-steel 18 Mesh 0.017 wire, 304 Stainless Steel 20 Mesh 0.016 wire or 304 Stainless Steel 16 Mesh 0.018 wire.

Inter Crimp in 304 Stainless-steel 18 Mesh 0.017 wire, 304 Stainless Steel 20 Mesh 0.016 wire or 304 Stainless Steel 16 Mesh 0.018 wire.

Plain weave in 304 Stainless-steel 18 Mesh 0.017 wire, 304 Stainless Steel 20 Mesh 0.016 wire or 304 Stainless Steel 16 Mesh 0.018 wire.

All of these variations will produce a good even consistency and separation but the preferred screen and type is Double Crimp 304 Stainless Steel 16 Mesh 0.018 wire.

It creates a perfect manual defoliating system design for the health of the consumer. Taking the stems, seeds and hard material out of the Cannabis and herbal foliage material making the consumable product healthier by eliminating nasty chemicals and unwanted material from the final product that normally in the past have been consumed creating excess coughing, headaches, and unwanted taste.

What Makes the Defoliator Stand Out from all Others on the Market?

Setting itself apart from all grinding machines on the market electric or not. The Defoliator separates all stem and hard material including micro stems from all usable foliage material, with little effort to the consumer. other grinding machines on the market employ sharp pointy laser-cut edges, blades or sharp textures to grind shred or mulch Cannabis or herbal material including hard plant nodules stems and micro stems into a somewhat unhealthy consumable product. These sharp edges and shapes are also dangerous to the consumer especially if Cannabis or herbal material becomes lodged in the sharp design of the Grinders and the consumer has to pick it out with their finger, And in some cases resulting in the need for minor medical attention. The Defoliator on the other hand employs soft edges truncated pyramids and flat surfaces along with a textured screen to strip all usable Cannabis and herbal foliage material from unusable Cannabis or herbal stems including micro stems allowing for a healthier consumption. the Defoliator is safe sturdy and built to last a lifetime. Built of quality and sanitary materials this Defoliator is a healthier choice than others on the market. The end product comes out thoroughly defoliated material that burns and steeps evenly and is void of stems and hard foliage material that would otherwise destroy rolling papers or cause an uneven burn, and in the realm of Edibles the bottom of the Deflator part labeled Collection Chamber can be removed and dried and cured Cannabis or herbal material can be defoliated directly over or into your dish to be consumed whether that be butter oil or just over your favorite pizza the Defoliator leaves no stem behind the Defoliator does not employ a micro screen or kief screen to ensure maximum potency and best flavors of the defoliated product.

How to Manufacture the Defoliator:

First a wooden blank is sanded into a perfect circle; the Top Peg 101 is then cut off to length. The cylinder Center of the remaining piece consisting of 102,103,105 and 106 is then bored out to a specific size and depth depending on model being manufactured. The now hollow cylinder with a solid bottom is then removed from the drill press and Separation Chamber 102 Is cut from the hollow cylinder with a solid bottom using a table saw. A whole guide is then placed on bottom of Separation Chamber 102 and three holes will be drilled evenly around the outer perimeter of the Separation Chamber 102. These holes will be used to attach brass rods 107 which will be used to hold all pieces together and in place. Hole guide will then be removed and placed on top of the remaining hollow cylinder 103,105 and 106 with a solid bottom, with the hole facing up towards the sky.

Three holes will then be drilled evenly around the Outer Perimeter of the top of the remaining Hollow cylinder 103,105 and 106 with a solid bottom using the hole guide to ensure accurate placement of the holes, these holes will be drilled in bottom of hollow cylinder but do not protrude out the bottom. The hollow cylinder is then taken to the table saw and Screen attachment-A 103 Is chopped off of hollow cylinder with solid bottom and set aside, the hollow cylinder with solid bottom is then taken and positioned on the table saw and Screen attachment-B

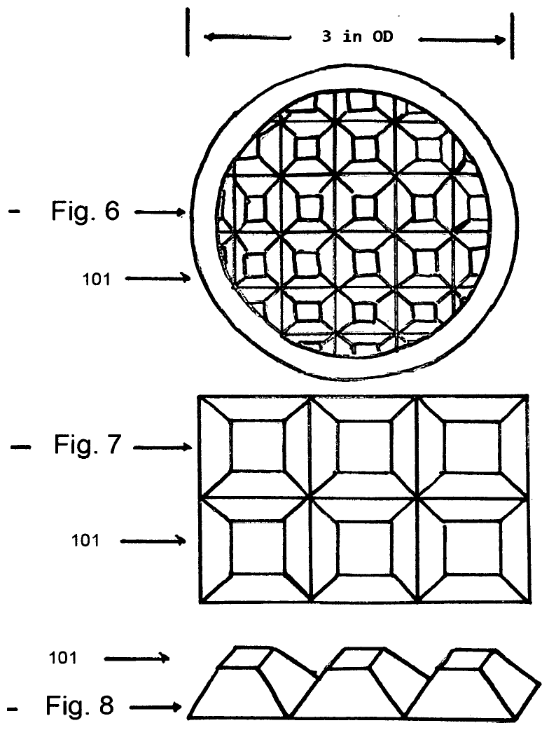

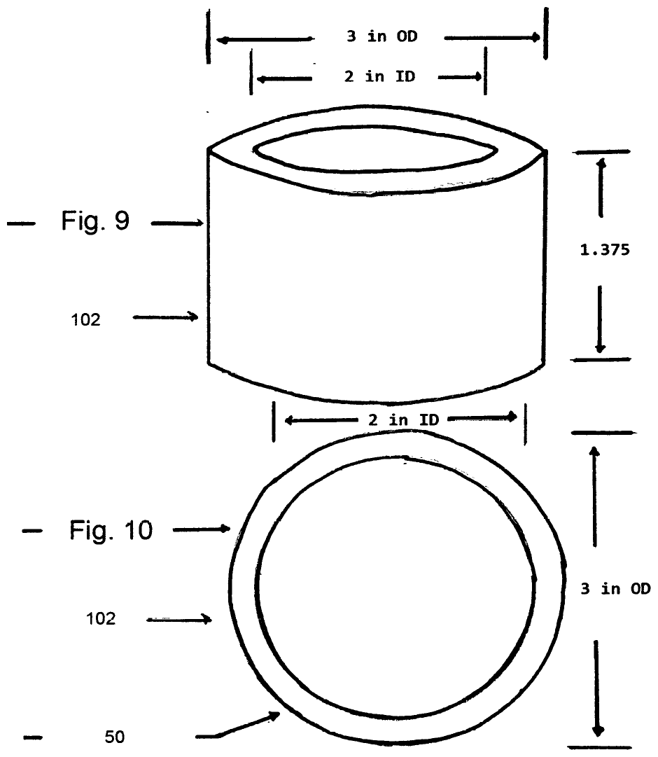

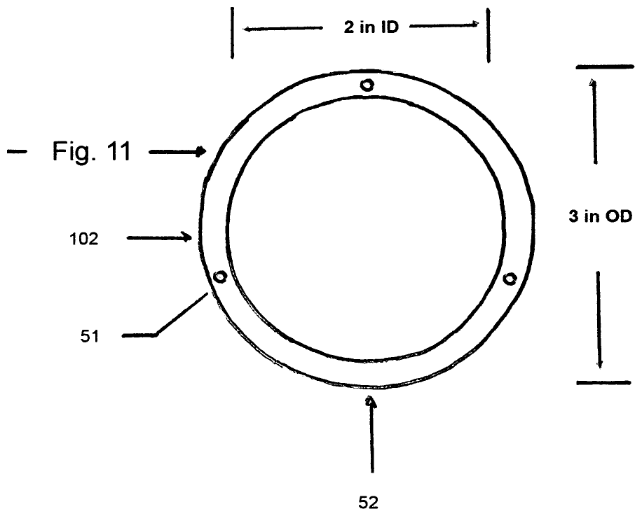

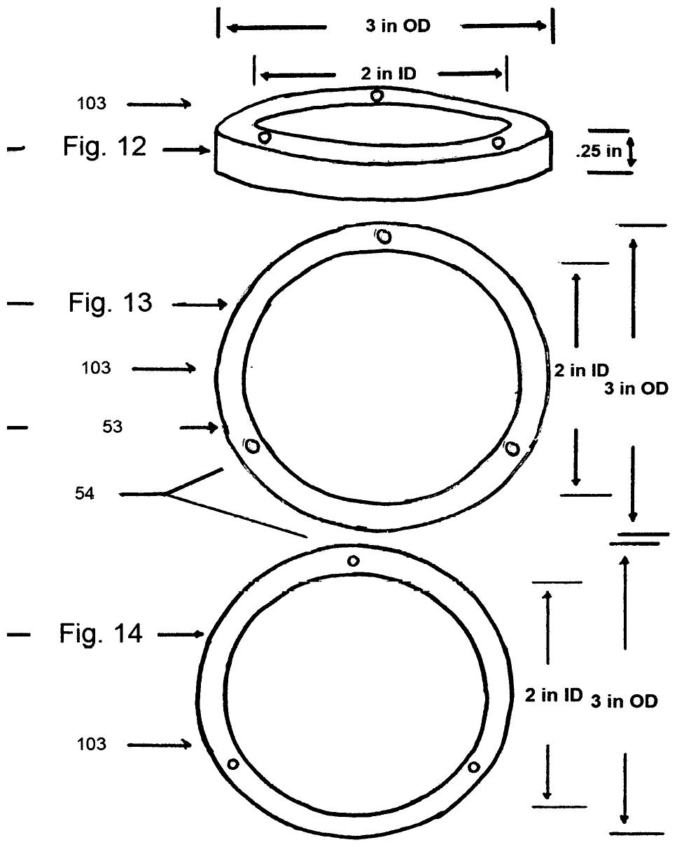

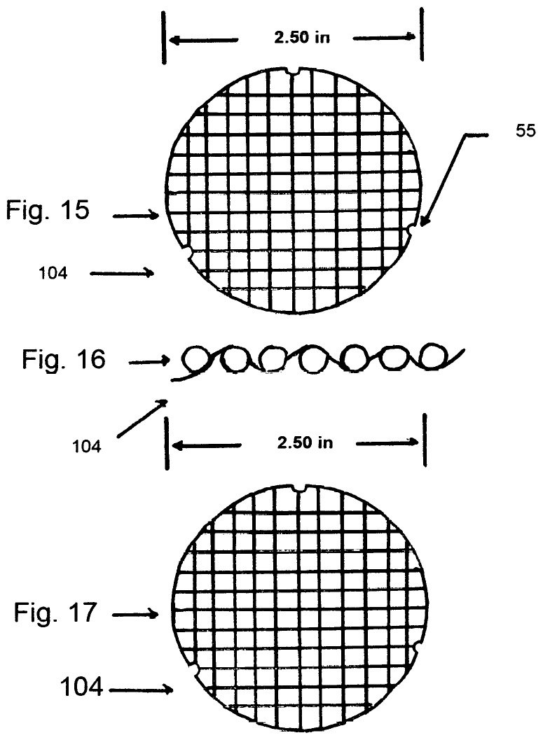

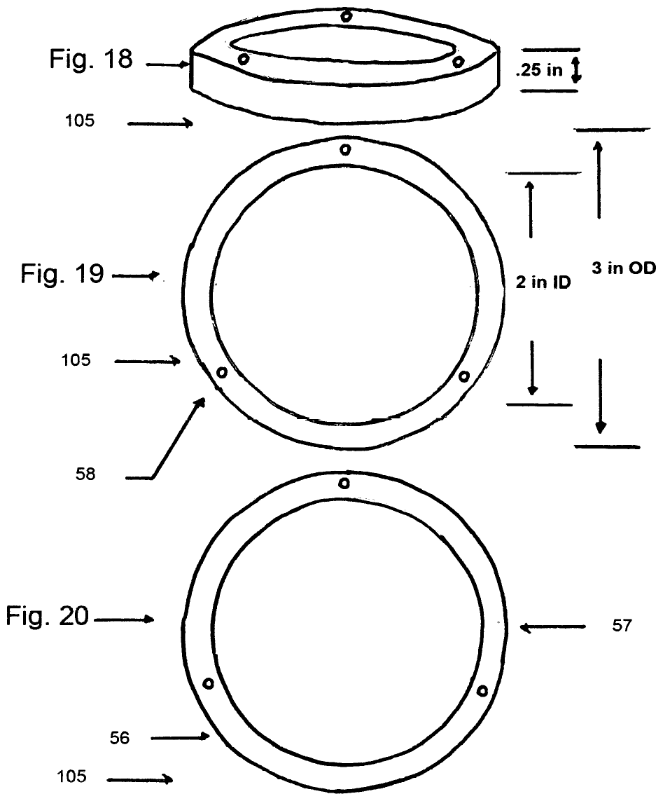

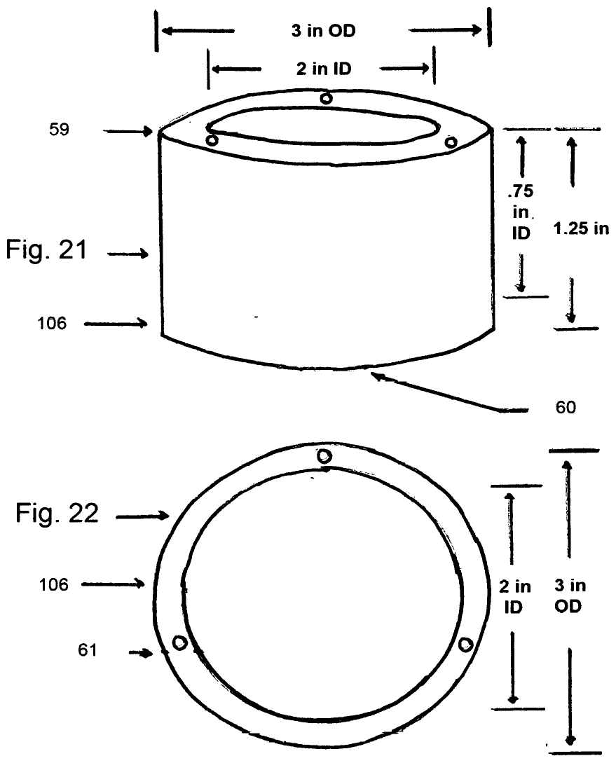

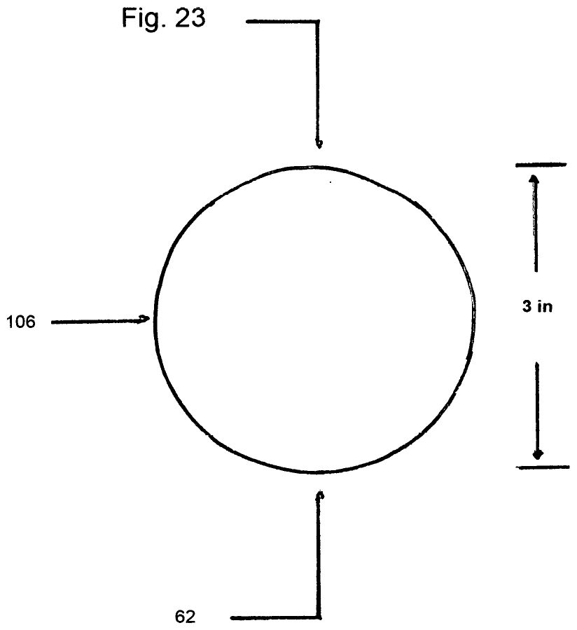

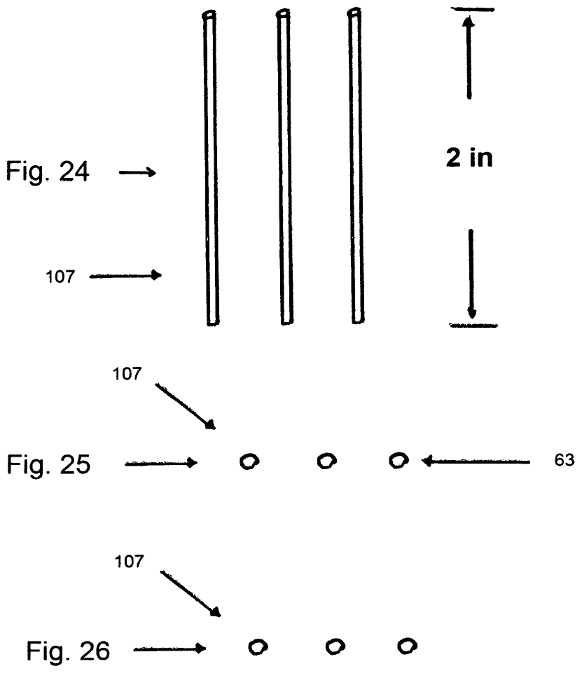

105 Is cut off of the hollow cylinder with solid bottom and set aside. The remaining part is a hollow cylinder with a solid bottom that will be the completed collection chamber 106. At this point brass rods are permanently inserted into holes drilled in bottom of Separation chamber 102. We then do a dry fit of all pieces to ensure flush fit on the outside and inside perimeter once quality is ensured the pieces will be set aside and the remaining piece that will become 101. Remaining blank will then be loaded into the drill press and a hole saw will be used to cut a slit in bottom of 101, the part is then taken to the lathe and spun at low speed and a cutoff tool is used to cut down to the slit made by the whole saw. The outer piece will fall off when you hit your mark leaving a peg with a diameter matching that of the inside diameter of the waiting separation chamber 102. Then peg will be sanded to match the inside diameter of the separation chamber 102 leaving you with an almost finished Top Peg 101. Top Peg 101 Is then taken to an automatic router table and the final texture FIG. 6, FIG. 7 and FIG. 8 of Top Peg 101 Is then carved into bottom of top Peg 101, creating a unique manual defoliation device. We then turn the piece to the top 101 being the widest part of Top Peg 101 and use an auto router to engrave the defoliator name of the invention in top lid of 101 of Top Peg 101. Top Peg 101 is now set aside and Screen attachment-A 103

And Screen attachment-B 105 are then glued and pressed to either side of Screen 104. Creating a sandwich with Screen attachment-A 103 and Screen attachment-B 105 on the outer parts and the screen 104 in the middle.

accommodating brass rods 107 holes will be punched in the screen 104 And once screen 104 is attached to screen attachment-A 103 And Screen attachment-B 105 The defoliator is hand sanded and oiled only on the outside and assembled, then quality check will be done again and the piece is put together 100 And the product is ready for use.

Of course the Defoliator can be manufactured in other specific and with other materials than those herein set forth without straying from the essential characteristics of the invention the current description and means of fabrication are therefore to be considered in all respects as illustrative and not restrictive The Entity of the invention is explained in great depth in the claims that follow.

How to Use the Defoliator:

The technology used in the Defoliator is as simple as it is to use.
Ensure all pieces are snugly fit together 100.
Remove top Peg 101
Place Whole cured Dried and manicured herbal material or Cannabis buds into the separation chamber 102, no need to break up the material or pick anything out Just enough to cover the screen caution do not overload the Defoliator.
Replace Top Peg 101 Back into the Separation Chamber 102 having texture FIG. 6, FIG. 7 and FIG. 8 Facing down on top of the Cannabis or herbal material.
grasp bottom of Collection Chamber 106 In one hand and grasp top lip of Top Peg 101 In the other hand Holding the defoliator at an ergonomically correct 45 degree angle Simply twist Top Peg 101 Inside of Collection Chamber 106, Applying as little pressure as necessary to move the herbal material or Cannabis buds around the screen as the Top Peg 101 Is twisted around the foliage material will be stripped from the stem and micro stems allowing it to fall into the collection chamber 106.

When you feel the texture change from smooth to somewhat rough pull the Top Peg 101 out of Separation Chamber 102 and give the side of the defoliator a tap to assist any loose foliage material to fall effortlessly into the collection chamber 106. At this point the consumer has a choice to continue defoliating or consume very clean Cannabis or herbal material. If defoliation is still needed simply replace Top Peg 101 and at this point do not apply any pressure simply spin Top Peg 101 in separation chamber 102 again applying no pressure allowing stems to slide over screen 104 and all remaining Cannabis or herbal material to fall into the collection chamber 106, leaving all stems and hard material on top of the screen 104.
Pull Collection Chamber 106 away from screen attachments and dump out healthier and cleaner Cannabis and herbal material ready for consumption.
Now for the real exciting part after dumping all material replace collection chamber 106 and pull Top Peg 101 out of Separation Chamber 102 and turn the defoliator upside down onto a hard surface and tap, you will see many micro stems that you never knew could be separated out this is the beauty and simplicity of the Defoliator. Then replaced top Peg 101 and you're done ready for the next defoliation.

I claim:

1. The Invention claimed is a manual defoliator which In laymen's terms is a grinder that separates herbal and Cannabis stem from foliage material and depositing it in the collection chamber below, comprising of a multitude of pieces starting at the top of Top Peg 101 Consisting of a round cylinder having two different vertical dimensions the first at the top being that of the outside dimension of all pieces and having a vertical body 20% that Of the total length of Top Peg 101
Downward from there is a vertical cylindrical body just slightly smaller than that of the inside diameter of the Separation Chamber 102 Consisting of the other 80% bottom portion of Top Peg 101 It is a smooth vertical cylindrical shaft that will extend vertically into the Separation Chamber on the bottom of this vertical shaft laying horizontally is the Texture FIG. 6, FIG. 7, and FIG. 8 Comprised of continuous rows of truncated pyramids extending in the X and Y directions horizontally to the edge of bottom of Top Peg 101 This is part one of the invention that is very important to the defoliation process as the texture of this peg completes 1 of the 3 requirements for successful defoliation
The Separation Chamber 102 Is the second part that is important to the invention this is a hollow cylinder with an inside diameter slightly larger than the above stated Top Peg shaft 101 This hollow cylinder is used to contain the Cannabis and herbal material inside the screen 104 area and orients the herbal material in a horizontal fashion allowing stems to be scraped and abraded not crushed cut or chopped this hollow cylinder is specifically cut to allow the shaft of Top Peg 101 to protrude out the bottom of the Separation Chamber 102 and all the way through to the next piece Screen Attachment-A 103.
The next part consists of three separate pieces glued and pressed together the pieces are screen attachment-A 103 screen 104 And screen attachment-B 105 When bonded together with food safe glue they create the third and most important aspect of the Defoliator
The screen area with its specific texture and spacing and bottom texture of Top Peg 101 and the actual screen 104 creates the perfect manual defoliation process the screen 104 Itself is not flat but weaved allowing for the perfect angular spacing mesh This screen has a bumpy texture that will allow foliage material to fall through to the collection chamber 106 and stems and micro stems are unable to be
Oriented in an angle that would allow them to pass through the screen due to the gravity of Top Peg and containment of Cannabis material by the separation chamber 106
The Collection chamber 106 is simply a collection container that captures clean Cannabis and herbal material consisting of a hollow cylinder with a solid bottom inside and outside dimensions are approximate to all other pieces
All pieces are held together with brass rods that are fed through pre drilled holes to create a seamless end product 100
all put together this creates a manual defoliation system that removes all stems and hard material including micro stems out of Cannabis and herbal foliage material creating a healthier consumable product so it is claimed by the inventor.

2. The defoliation system of claim 1, where in the Defoliator is a device that strips all foliage materials from stem and trunk and separates out the usable foliage material.

3. The defoliation system of claim 1, where in multitude of pieces is equivalent to Top Peg, Collection Chamber, Screen Attachment-A Screen Attachment-B Screen and Collection Chamber.

4. The defoliation system of claim 1, where in a vertical cylindrical body is round and smooth and oriented in a vertical direction.

5. The defoliation system of claim 1, wear in Separation Chamber has a hollow cylinder with an inside diameter matching that of all other pieces and is oriented in a vertical direction.

6. The defoliation system of claim 1, where in Texture is a system of truncated pyramids located on bottom of Top Peg running in both the X and Y directions.

7. The defoliation system of claim 1, wherein invention is simply the Defoliator in its entirety.

8. The defoliation system of claim 1, where in Cannabis and herbal material is dried cured and manicured Marijuana buds or herbal material such as whole Basil, Saffron or Rosemary.

9. The defoliation system of claim 1, where in three separate pieces consists of Screen Attachment-A Screen and Screen Attachment-B.

10. The defoliation system of claim 1, where in specific spacing is a reference to Dimensions given in drawings and the spacing of parts in correlation to each other.

11. The defoliation system of claim 1, where in pressed is the use of a hydraulic press and food safe glue to bond pieces together.

12. The defoliation system of claim 1, where in weaved is an over-under type of weaved screen material. Generally made of 304 Stainless steel but other materials may be used in its place.

13. The defoliation system of claim 1, where in foliage is the soft leafy material that grows on Cannabis and herbal stems.

14. The defoliation system of claim 1, where in Collection Chamber is a hollow cylinder with a solid bottom that collects the cleaner healthier foliage material that is processed and ready for consumption.

15. The defoliation system of claim 1, where in brass rods are small cylindrical rods made of brass for holding pieces together and in place creating a seamless end product.

16. The defoliation system of claim 1, where in consumable product is the material that is separated from stem and hard material and consumed by the customer.

17. The defoliation system of claim 1, where in micro stems are stems of Cannabis or other herbal material that are so small that it would be almost impossible to pick them out by hand.

18. The defoliation system of claim 1, where in hard material is anything that is of a density that it cannot be broken down with the soft edges of the Texture and the texture of the screen example seeds, stems, pre seeds or hard nodular plant masses.

19. The defoliation system of claim 1, where in manual defoliation system is all pieces placed together and used in the matter it was designed and explained in this patent.

20. The defoliation system of claim 1, where in bonded is the use of food safe glue.
